(19) United States
(12) Patent Application Publication
(10) Pub. No.: US 2026/0031579 A1
(43) Pub. Date: Jan. 29, 2026

(54) DOWNSTOP COLUMN SENSORS FOR SOCKET CREEP DETECTION

(71) Applicant: INTERNATIONAL BUSINESS MACHINES CORPORATION, ARMONK, NY (US)

(72) Inventors: NOAH SINGER, WHITE PLAINS, NY (US); JOHN S. WERNER, FISHKILL, NY (US); JOHN TOROK, POUGHKEEPSIE, NY (US); ARKADIY O. TSFASMAN, WAPPINGERS FALLS, NY (US); LUKE L. JENKINS, POUGHKEEPSIE, NY (US)

(21) Appl. No.: 18/785,257

(22) Filed: Jul. 26, 2024

(51) Int. Cl. H01R 13/66; G01M 5/00; G06F 11/30; H01R 12/70

(52) U.S. Cl. CPC H01R 13/6683; G01M 5/0041; G06F 11/3024; G06F 11/3058; H01R 12/7076

(57) ABSTRACT

Methods, systems, and products for socket downstop creep detection includes monitoring one or more creep detection sensors included within one or more downstops within a socket, where the socket is included on a printed circuit board (PCB) and a module is coupled to the socket, detecting socket downstop creep associated with the module based on data received from the one or more creep detection sensors, and performing one or more actions based on detecting the socket downstop creep.

### BACKGROUND

### Field of the Disclosure

The field of the disclosure is data processing, or, more specifically, methods, systems, and products for socket downstop creep detection.

### Description Of Related Art

Sockets on a circuit board include mechanical and electrical connections to couple a computer module (such as a processor) to the circuit board without soldering. Sockets often include downstops that act to prevent the module from compressing the electrical pins past a certain point. That is, modules coupled to a socket experience continuous mechanical stress and compression, and the downstops included in the socket keep the module in proper contact with the circuit board. The socket downstops, which are under constant mechanical stress, may experience creep, causing the downstops to compress and allow the module to come closer to the circuit board. When downstop creep occurs, the processor and/or the contact pins of the socket are over compressed and may misalign with the contact pads of the module or get damaged.

### SUMMARY

Methods, apparatus, and systems for socket downstop creep detection according to various embodiments are disclosed in this specification. In accordance with one aspect of the present disclosure, a method of socket downstop creep detection includes monitoring one or more creep detection sensors included within one or more downstops within a socket, where the socket is included on a printed circuit board (PCB) and a module is coupled to the socket, detecting socket downstop creep associated with the module based on data received from the one or more creep detection sensors, and performing one or more actions based on detecting the socket downstop creep.

In accordance with another aspect of the present disclosure, an apparatus for socket downstop creep detection may include a module including multiple contact pads, and a printed circuit board (PCB) comprising a socket for receiving the module, where the socket includes: multiple pins configured to contact the multiple contact pads of the module when the module is coupled to the socket; multiple downstops coupled to a socket base, and one or more creep detection sensors included within one or more of the downstops, where each creep detection sensor is configured to detect a threshold amount of creep within the socket.

In accordance with another aspect of the present disclosure, an apparatus for socket downstop creep detection may include a module including multiple contact pads, a socket for receiving the module, where the socket includes: a socket base, multiple downstops mounted on the socket base, multiple pins configured to contact the multiple contact pads of the module when the module is coupled to the socket, and one or more creep detection sensors mounted on the socket base and proximate to a pin of the multiple pins, where each creep detection sensor is configured to detect a threshold amount of creep within the socket, and a printed circuit board (PCB) coupled to the socket and comprising a sensor monitoring circuit coupled to the one or more creep detection sensors.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a system configured for socket downstop creep detection in accordance with embodiments of the present disclosure.

FIG. 2 shows an example line drawing of a system configured for socket downstop creep detection in accordance with embodiments of the present disclosure.

FIG. 3 is a block diagram of an example computing environment configured for socket downstop creep detection according to some embodiments of the present disclosure.

FIG. 4 shows an example line drawing of another system configured for socket downstop creep detection in accordance with embodiments of the present disclosure.

FIG. 5 shows an example line drawing of another system configured for socket downstop creep detection in accordance with embodiments of the present disclosure.

FIG. 6 is a block diagram of an example network diagram configured for socket downstop creep detection according to some embodiments of the present disclosure.

FIG. 7 is a flowchart of an example method for socket downstop creep detection according to some embodiments of the present disclosure.

### DETAILED DESCRIPTION

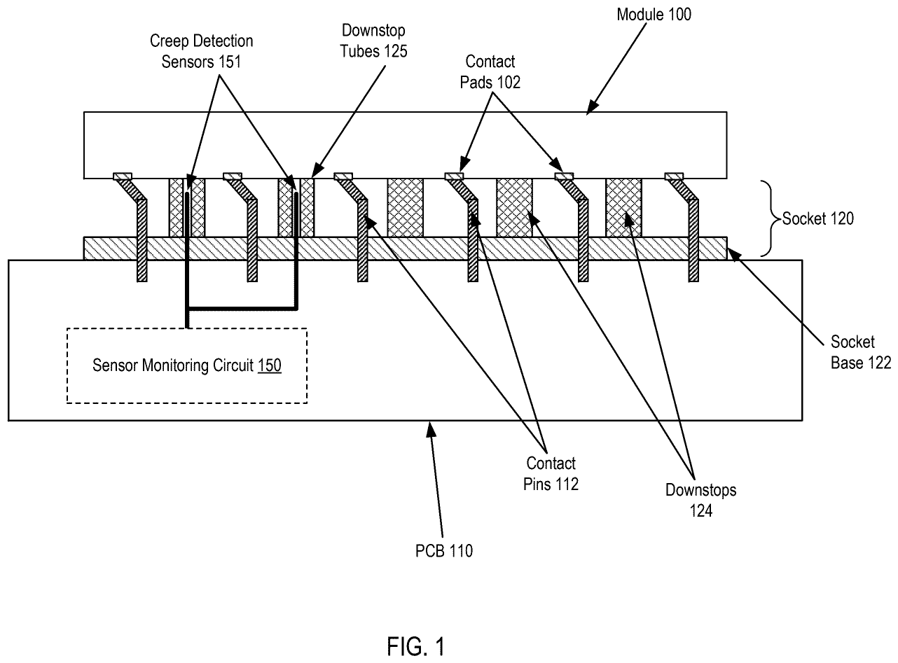

Exemplary methods, systems, and products for socket downstop creep detection in accordance with the present disclosure are described with reference to the accompanying drawings, beginning with FIG. 1. FIG. 1 sets forth an example line drawing of a system configured for socket downstop creep detection in accordance with embodiments of the present disclosure. The example system of FIG. 1 includes a PCB 110, a socket 120 on the PCB having a socket base 122 and multiple downstops 124, a module 100 coupled to the PCB through the socket of the PCB, one or more creep detection sensors 151 included within one or more of the downstops 124, and a sensor monitoring circuit 150 included within the PCB.

The example PCB 110 of FIG. 1 is configured to couple multiple different computer components to one another. Some components may be soldered onto the PCB while other components may be coupled to the PCB without soldering (such as through the use of a socket or some other electrical connection or mount). The example PCB of FIG. 1 includes multiple contact pins 112 that protrude away from the PCB through the socket 120.

The example socket 120 includes socket base 122 which is positioned on a top surface of the PCB 110. The socket 120 also includes one or more downstops 124 configured to prevent the module 100 from compressing (or bending) the contact pins 112 past a certain point. The material of the socket (such as the downstops and the socket base) may be any non-conductive material, such as a liquid crystal polymer (LCP) material. Because modules coupled to a socket experience continuous mechanical stress and compression forces, the downstops included in the socket keep the module in proper contact with the circuit board. The contact pins 112 protrude through the socket and are configured to contact the one or more contact pads 102 included in the module 100 when the module is coupled to the socket. The contact pins are positioned between the downstops of the socket.

The example module 100 includes one or more contact pads 102 configured to contact the one or more contact pins 112 of the PCB when the module is coupled to the socket. The example module 100 may be a processor, a controller, a graphics processing unit, memory, or any other computer component configured to be coupled to the PCB through a socket.

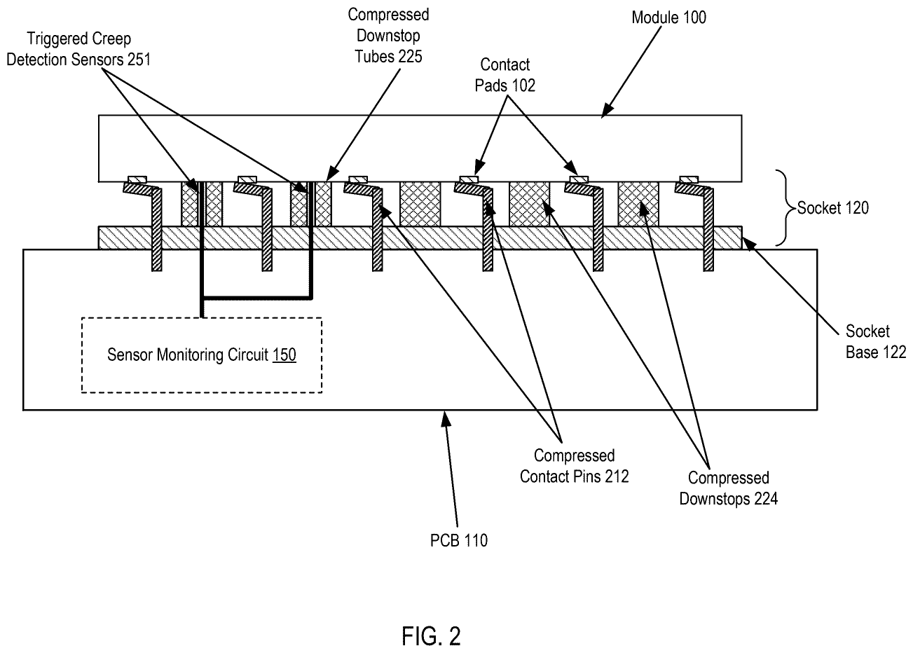

Creep (a form of deformation) is the tendency of a solid material to undergo slow deformation when subjected to continued mechanical stress. Creep is typically more severe in materials that also experience increased levels of heat. The socket downstops, which are under constant mechanical stress, may experience creep, causing the downstops to compress and allow the module to come closer to the circuit board. When downstop creep occurs, the processor and/or the contact pins of the socket are over compressed and may misalign with the contact pads of the module or get damaged (see FIG. 2 for more detail). For example, the module of FIG. 1 is depicted as being properly coupled to the PCB through the socket. Even when properly coupled, the contact pins 112 deflect or bend slightly (while still contacting the contact pads 102) so that they remain in contact with the contact pads with a constant pressure. When the socket experiences creep, however, such as shown in the example of FIG. 2, the contact pins 112 may break or may deflect or bend even more so than depicted in FIG. 1, which could cause the contact pins to slip off of (or become misaligned with) the contact pads 102, further causing errors, loss of signal, loss of module functionality, or other performance issues. Damaged contact pins 112 would require replacement of the PCB in an end-product, which may require a large cost of money or downtime for the system. Creep may occur evenly across the socket or may occur unevenly (where different downstops in the socket experience more creep than others), which could lead to chip cracking.

The example PCB 110 of FIG. 1 includes multiple creep detection sensors 151 positioned within the downstops and configured to detect creep within the socket 120. The downstops including creep detection sensors may be hollow (such as the downstop tubes 125 shown in FIG. 1) and allow space for a sensor the be positioned within the downstop tube. The creep detection sensors are free-floating within the downstop tubes 125 and are mounted to the socket via the socket base 122. The creep detection sensors are configured to be shorter than the length of the downstops by a set amount so as to not contact the module when the module is properly mounted to the socket (without downstop creep). As downstops experience creep, the sensors will get closer to the module until they eventually contact the module.

In one embodiment, the creep detection sensors 151 are configured to detect the threshold amount of creep within the socket based on the one or more creep detection sensors contacting the module. For example, the creep detection sensor may be a simple electrical contact or set of wires configured to close a circuit when contacting the module, thereby detecting the threshold amount of creep. In such an embodiment, the creep detection circuit does not detect creep until the threshold amount of creep has occurred. For example, in an embodiment where the creep detection sensors are 75% the length of the downstops (such as the example depicted in FIG. 1), such a creep detection sensor would only detect the presence of downstop creep when the creep detection sensor contacts the module, thereby closing the circuit, and indicating the threshold amount of creep (25% creep) has occurred. In some embodiments, there are multiple creep detection sensors included within the socket, where the create detection sensors are different in length. By having multiple sensors of varying lengths included within a socket, multiple different amounts of creep may be detected within the socket. For example, if the socket includes one or more creep detection sensors that are 80% the length of the downstops, one or more creep detection sensors that are 70% the length of the downstops, and one or more creep detection sensors that are 60% the length of the downstops, then such a socket is configured to detect three different amounts of creep within the associated sockets. In such an example, the creep detection sensors will detect and indicate the varying levels of creep as they occur and continue to increase. In one embodiment, there may be multiple groups of creep detection sensors included within the socket, where each group of creep detection sensors includes two or more sensors with different lengths (so as to detect multiple levels of creep).

In another embodiment, the creep detection sensors may be a pressure sensor, such as a piezoelectric pressure sensor. In such an embodiment, the creep detection sensor detects the presence of downstop creep when the creep detection sensor experiences pressure from contacting the module. In another embodiment, the creep detection sensors are configured to detect a distance between the creep detection sensor and the module. In such an embodiment, where the sensors are distance measuring sensors, the creep detection sensor may continuously keep track of the amount of creep present in the associated downstop tube 25, since such a sensor does not require contact with the module to determine the amount of creep present.

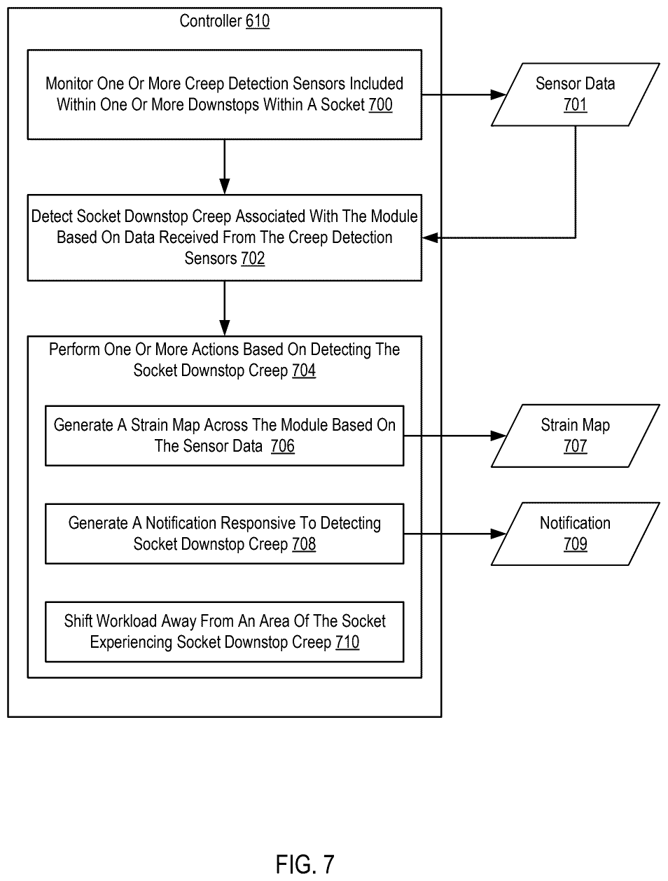

The example sensor monitoring circuit 150 of FIG. 1 is included within the PCB 110 and is coupled to one or more of the creep detection sensors included within the socket 120. In one embodiment, a single sensor monitoring circuit 150 is coupled to all of the creep detection sensors included within the socket 120 (as shown in FIG. 1). In another embodiment, there may be a separate sensor monitoring circuit for each creep detection sensor included within the socket. In another embodiment, there may be a separate sensor monitoring circuit for each group of creep detection sensors included within the socket. The sensor monitoring circuit 150 is configured to receive sensor data from the create detection sensors, and relay that sensor data to a processor or controller for further action (see FIG. 7 for more detail).

In the example embodiment of FIG. 1, two creep detection sensors are included at one end of the socket. In such an embodiment, the socket is configured to detect creep within the down stops at that end of the socket. In another embodiment, there may be a creep detection sensor included within every down stop of the socket. Such an embodiment would allow for the detection of creep at any downstop included within the socket. In another embodiment, there may be a creep detection sensor included within every other downstop of the socket, or included in a grid pattern across the socket, around the perimeter of the socket, at each corner of the socket, or in any other type of pattern. By positioning the creep detection sensors at various locations across the socket, downstop creep may be more easily and accurately detected, especially when downstop creep occurs unevenly across the socket.

For further explanation, FIG. 2 sets forth another example line drawing of a system configured for socket downstop creep detection in accordance with embodiments of the present disclosure. The system of FIG. 2 differs from the system of FIG. 1 in that the system of FIG. 1 depicts a module properly coupled to the socket without the presence of downstop creep, while FIG. 2 depicts a socket that is experiencing downstop creep. The system of FIG. 2 includes, in addition to the elements of FIG. 1, triggered creep detection sensors 251, compressed downstop tubes 225, compressed downstops 224, and compressed contact pins 212.

The example of FIG. 2 depicts even creep across the entire module, where each downstop has experienced the same amount of creep and thus has compressed the same amount. The example contact pins are compressed beyond their original design and thus no longer correctly contact the contact pads 102 of the module. The compressed downstops 224 have become shorter and wider when compared to the downstops of FIG. 1. The creep detection sensors in FIG. 2 have been triggered because they are in contact with the module 100 (due to the downstop creep). The downstop tubes are configured to experience the same amount of creep as the surrounding downstops. In such an embodiment, the sensor monitoring circuit is configured to receive sensor data from the triggered creep detection sensors indicating the detected downstop creep and will send the sensor data to a processor or controller so that further actions may be performed to address the downstop creep.

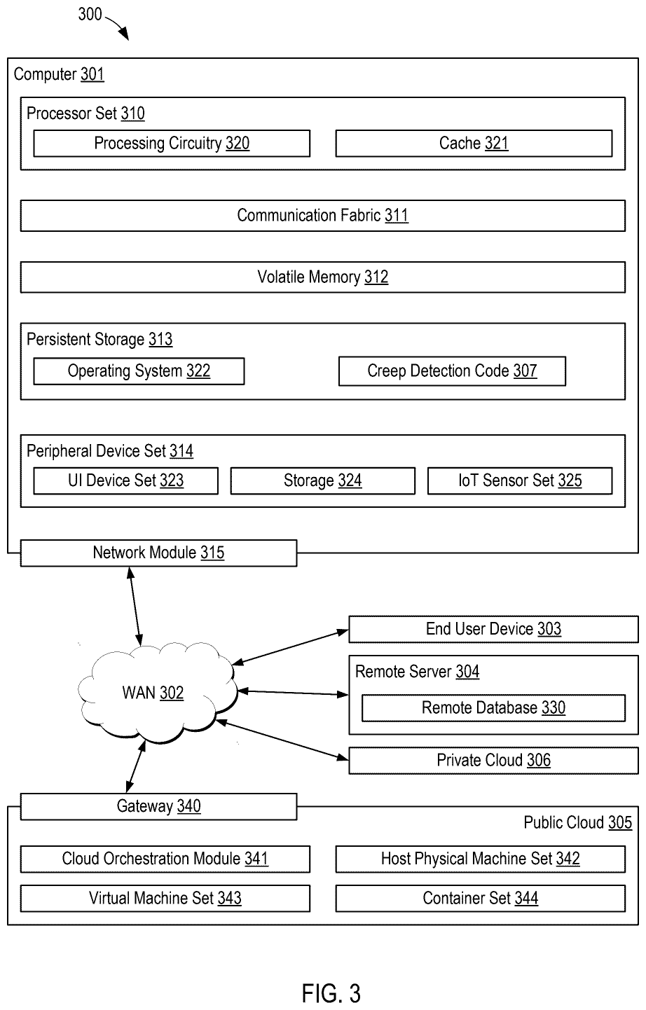

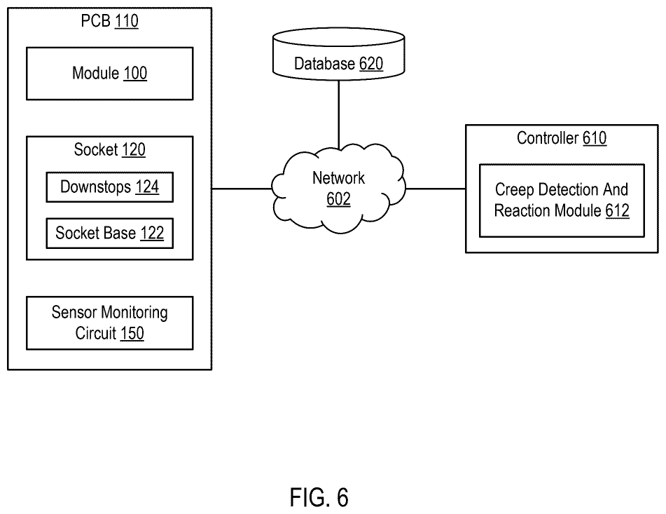

For further explanation, FIG. 3 sets forth a block diagram of computing environment 300 configured for socket downstop creep detection in accordance with embodiments of the present disclosure. Computing environment 300 contains an example of an environment for the execution of at least some of the computer code involved in performing the inventive methods, such as creep detection code 307. In addition to creep detection code 307, computing environment 300 includes, for example, computer 301, wide area network (WAN) 302, end user device (EUD) 303, remote server 304, public cloud 305, and private cloud 306. In this example embodiment, computer 301 is a computing system comprising controller 610 of FIG. 6, and includes processor set 310 (including processing circuitry 320 and cache 321), communication fabric 311, volatile memory 312, persistent storage 313 (including operating system 322 and creep detection code 307, as identified above), peripheral device set 314 (including user interface (UI) device set 323, storage 324, and Internet of Things (IOT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in creep detection code 307 in persistent storage 313. In one embodiment, the creep detection code 307 is included in creep detection and reaction module 612 of FIG. 6.

Communication fabric 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in creep detection code 307 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315. Network module 315 may be configured to communicate with other systems or devices, such as sensors 325, for receiving sensor measurements.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

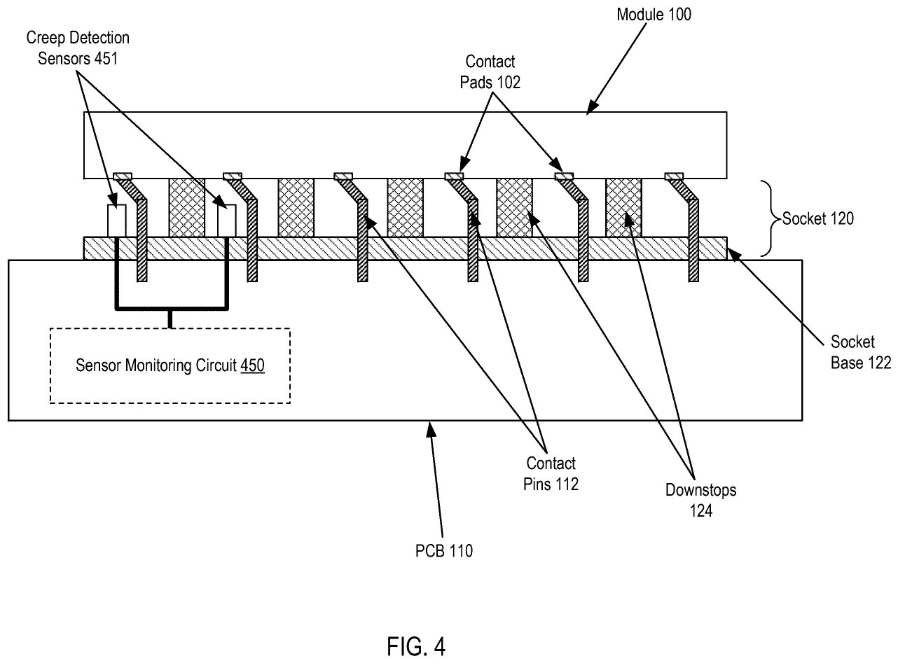

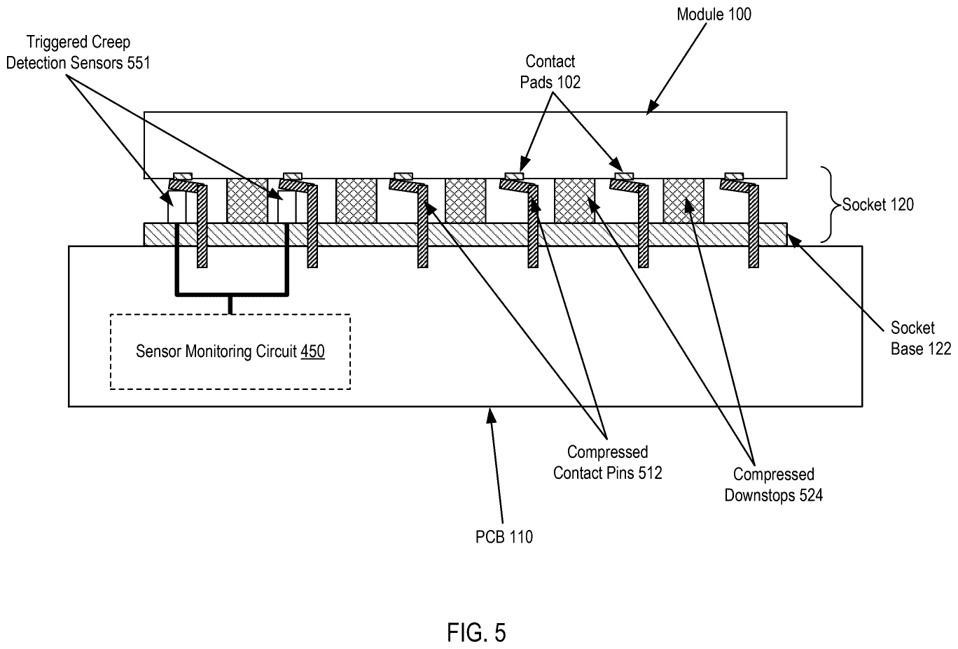

For further explanation, FIG. 4 sets forth an example line drawing of another system configured for socket downstop creep detection in accordance with embodiments of the present disclosure. The system of FIG. 4 differs from the system of FIG. 1 in that the system of FIG. 4 includes creep detection sensors mounted to the socket base 122 outside of the downstops 124 (instead of within the downstops, as depicted in FIG. 1). Specifically, the example creep detection sensors 451 of FIG. 4 are mounted to the socket base 122 proximate to the contact pins of the socket. The creep detection sensors 451 are configured to contact the contact pins when a threshold amount of creep has occurred (see FIG. 5 for more detail).

In one embodiment, the creep detection sensors 451 are configured to detect the threshold amount of creep within the socket based on the creep detection sensor closing a circuit by contacting a proximate pin of the plurality of pins. For example, the tip of the contact pins continues to bend as creep occurs, and once the socket has experienced the threshold amount of creep, the pin will deflect enough to contact the proximate creep detection sensor (see FIG. 5).

In another embodiment, the creep detection sensors 451 are pressure sensors, such as piezoelectric pressure sensors. In such an embodiment, each creep detection sensor is configured to detect the threshold amount of creep within the socket based on the creep detection sensor contacting a proximate contact pin with a threshold amount of pressure. For example, as creep occurs and increases, the tip of the contact pin will deflect to eventually contact the proximate sensor and will continue to increase the pressure on the sensor until the threshold amount of pressure on the sensor is reached and thus triggers the sensor to detect the threshold amount of creep.

For further explanation, FIG. 5 sets forth another example line drawing of a system configured for socket downstop creep detection in accordance with embodiments of the present disclosure. The system of FIG. 5 differs from the system of FIG. 4 in that the system of FIG. 4 depicts a module properly coupled to the socket without the presence of downstop creep, while FIG. 5 depicts a socket that is experiencing downstop creep. The system of FIG. 5 includes, in addition to the elements of FIG. 4, triggered creep detection sensors 551, compressed downstops 524, and compressed contact pins 512.

The example of FIG. 5 depicts even creep across the entire module, where each downstop has experienced the same amount of creep and thus has compressed the same amount. The example contact pins are compressed beyond their original design and thus no longer correctly contact the contact pads 102 of the module. The compressed downstops 524 have become shorter and wider when compared to the downstops of FIG. 4. The creep detection sensors in FIG. 5 have been triggered because they are in contact with the proximate contact pins (due to the downstop creep). In such an embodiment, the sensor monitoring circuit 450 is configured to receive sensor data from the triggered creep detection sensors indicating the detected downstop creep, and will send the sensor data to a processor or controller so that further actions may be performed to address the downstop creep. The embodiment of FIG. 4 and FIG. 5 allows for the detection of creep without modifying the downstops of the socket (such as making them hollow and inserting sensors into the downstops).

For further explanation, FIG. 6 sets forth a block diagram of a network diagram configured for socket downstop creep detection in accordance with embodiments of the present disclosure. The network diagram of FIG. 6 includes a network 602 configured to communicatively couple the PCB 110 of FIG. 1 with a database 620 and a controller 610. The example PCB 110 may be the PCB of FIG. 1 or any other PCB configured with a sensor monitoring circuit 150. The example network 602 may be any computer network configured to communicatively couple one or more computer systems or components. The example controller 610 is configured to carry out the example embodiments of the present disclosure (including the method depicted in FIG. 7). The controller may be a processor, a microcontroller, or any other controller configured to send, receive, or execute instructions. The example controller 610 is configured to operate the sensor monitoring circuit and receive data from the creep detection sensors. The example controller 610 is also configured to store the data associated with the sensor monitoring circuit in the database 620. In the example embodiment of FIG. 6, the database, the controller, and the PCB are communicatively coupled via network 602. In another embodiment, the controller, the database, and the PCB are directly coupled within the same computer system. In one embodiment, the controller 610 is configured to carry out the various embodiments of the present disclosure without utilizing a database.

For further explanation, FIG. 7 sets forth a flow chart illustrating an exemplary method of socket downstop creep detection according to embodiments of the present disclosure. The method of FIG. 7 includes monitoring 700 one or more creep detection sensors included within one or more downstops within a socket. Monitoring 700 one or more creep detection sensors included within one or more downstops within a socket may be carried out by a controller (such as controller 610) by checking for any sensor data 701 received from the one or more creep detection sensors. The controller 610 may be a controller included within the PCB or separate from the PCB and within the computing system comprising the PCB. The sensor data 701 may include data indicating whether or not downstop creep was detected within the downstop associated with the respective creep detection sensor.

The method of FIG. 7 also includes detecting socket downstop creep associated with the module based on data received from the creep detection sensors. Detecting 702 socket downstop creep associated with the module may be carried out by a controller (such as controller 610) receiving sensor data 701 that indicates the presence of downstop creep associated with one or more downstops. The received sensor data may include position information indicating which downstop within the socket is experience creep, information related to the amount of creep detected, and other related information.

The method of FIG. 7 also includes performing 704 one or more actions based on detecting the socket downstop creep. Performing 704 one or more actions based on detecting the socket downstop creep may be carried out by a controller (such as controller 610) responsive to detecting creep in the socket to either correct, notify, or determine additional information about, the downstop creep. For example, the one or more actions may include (but is not limited to) generating a strain map across the module, generating a notification of the detected creep, shifting workload away from the area experiencing creep, and the like.

The method of FIG. 7 also includes, as part of performing 704 one or more actions based on detecting the socket downstop creep, generating 706 a strain map across the module based on the sensor data. Generating 706 a strain map 707 across the module based on the sensor data may be carried out by a controller (such as controller 610) by including, in a representation of the layout of the socket, indications of how much downstop creep each section or area of the socket (corresponding with each creep detection sensor included in the socket) is experiencing. In another embodiment, the strain map also indicates the rate at which downstop creep is increasing for each area of the socket. In one embodiment, the controller is configured to periodically (at preset intervals, or any time additional new sensor data is received) update the strain map. By keeping track of the history of the strain map, the strain map history may indicate the rate at which downstop creep is increasing for each area of the socket.

The method of FIG. 7 also includes, as part of performing 704 one or more actions based on detecting the socket downstop creep, generating 708 a notification responsive to detecting socket downstop creep associated with the module. Generating 708 a notification 709 responsive to detecting socket downstop creep associated with the module may be carried out by a controller (such as controller 610) by creating a notification 709 comprising an indication of socket downstop creep and information identifying both the socket and an area of the socket that is experiencing socket downstop creep. The notification 709 may be stored in memory (such as database 620, sent to an administrator of a system comprising the PCB and the controller 610, or stored in a remote system. In one embodiment, the notification is a call home signal or a system reference code (SRC).

The method of FIG. 7 also includes, as part of performing 704 one or more actions based on detecting the socket downstop creep, shifting 710 workload away from an area of the socket experiencing socket downstop creep. Shifting 710 workload away from an area of the socket experiencing socket downstop creep may be carried out by a controller (such as controller 610) responsive to the controller detecting the presence of socket downstop creep. Shifting 710 workload includes sending workload to a different location than the area of the socket that is experiencing downstop creep. In one embodiment where the module coupled to the socket includes a processor having multiple cores, the workload may be shifted from the core most closely proximate to the area of the socket experiencing downstop creep to another core on the processor that is further away from the area experiencing downstop creep. In another embodiment, where the module coupled to the socket includes multiple processors, the workload given to the processor proximate to the area experiencing downstop creep may be shifted to another processor on the module (such as a processor that is further away from the area experiencing downstop creep). In another embodiment, the workload being sent to the module experiencing downstop creep may be shifted to a different module (whether on the same socket or on a separate socket).

In view of the explanations set forth above, readers will recognize that the benefits of socket downstop creep detection according to embodiments of the present disclosure include:
Increasing socket reliability by detecting downstop creep, preventing future errors or system failures from occurring.
Increasing component longevity by detecting downstop creep, allowing for components to be serviced prior to becoming damaged.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An apparatus comprising:
a module including multiple contact pads; and
a printed circuit board (PCB) comprising a socket for receiving the module, wherein the socket includes:
a plurality of pins configured to contact the multiple contact pads of the module when the module is coupled to the socket;
a plurality of downstops coupled to a socket base; and
one or more creep detection sensors included within one or more of the plurality of downstops, wherein each creep detection sensor is configured to detect a threshold amount of creep within the socket.

2. The apparatus of claim 1, wherein the one or more of the plurality of downstops comprising the one or more creep detection sensors are hollow.

3. The apparatus of claim 1, wherein the one or more creep detection sensors are mounted to the socket base and free floating within its associated downstop.

4. The apparatus of claim 1, wherein the one or more creep detection sensors are configured to detect the threshold amount of creep within the socket based on the one or more creep detection sensors contacting the module.

5. The apparatus of claim 1, wherein the one or more creep detection sensors are configured to detect a distance between the creep detection sensor and the module.

6. The apparatus of claim 1, wherein the one or more creep detection sensors are a piezoelectric pressure sensor.

7. The apparatus of claim 1, wherein the one or more creep detection sensors are configured to close a circuit when contacting the module, thereby detecting the threshold amount of creep.

8. The apparatus of claim 1, wherein multiple creep detection sensors are included within the socket, and wherein one or more of the multiple creep detection sensors are different in length.

9. The apparatus of claim 1, further comprising a sensor monitoring circuit within the PCB and coupled to the one or more creep detection sensors.

10. An apparatus comprising:
a module including multiple contact pads;
a socket for receiving the module, wherein the socket includes:
a socket base;
a plurality of downstops mounted on the socket base;
a plurality of pins configured to contact the multiple contact pads of the module when the module is coupled to the socket; and
one or more creep detection sensors mounted on the socket base and proximate to a pin of the plurality of pins, wherein each creep detection sensor is configured to detect a threshold amount of creep within the socket; and
a printed circuit board (PCB) coupled to the socket and comprising a sensor monitoring circuit coupled to the one or more creep detection sensors.

11. The apparatus of claim 10, wherein each creep detection sensor is configured to detect the threshold amount of creep within the socket based on the creep detection sensor closing a circuit by contacting a proximate pin of the plurality of pins.

12. The apparatus of claim 10, wherein each creep detection sensor is configured to detect the threshold amount of creep within the socket based on the creep detection sensor contacting a proximate pin of the plurality of pins with a threshold amount of pressure.

13. The apparatus of claim 10, further comprising a controller configured to receive data from the sensor monitoring circuit.

14. The apparatus of claim 13, wherein the controller is communicatively coupled to a database configured to store the data from each creep detection sensor.

15. A method for socket downstop creep detection, the method comprising:
monitoring one or more creep detection sensors included within one or more of a plurality of downstops within a socket, wherein the socket is included on a printed circuit board (PCB), and wherein a module is coupled to the socket;
detecting socket downstop creep associated with the module based on data received from the one or more creep detection sensors; and
performing one or more actions based on detecting the socket downstop creep.

16. The method of claim 15, wherein the one or more actions includes generating a notification responsive to detecting the socket downstop creep.

17. The method of claim 15, wherein the one or more actions includes shifting workload away from an area experiencing the socket downstop creep.

18. The method of claim 17, wherein the workload is shifted to one of: another core on the module, another processor on the module, and another module.

19. The method of claim 15, further comprising generating a strain map across the module based on the data received from the one or more creep detection sensors.

20. The method of claim 19, further comprising periodically updating the strain map based on newly received data from the one or more creep detection sensors.
